(19) United States
(12) Patent Application Publication
(10) Pub. No.: US 2016/0325819 A1
(43) Pub. Date: Nov. 10, 2016

(54) SOLAR PANEL DEVICE PROVIDED ON AIRCRAFT WING, AIRCRAFT WING HAVING SOLAR PANEL DEVICE, AND AIRCRAFT

(71) Applicant: KOREA AEROSPACE RESEARCH INSTITUTE, Daejeon (KR)

(72) Inventors: Sang Wook PARK, Daejeon (KR); Jeong Woo SHIN, Daejeon (KR); Yung-Gyo LEE, Daejeon (KR); Tae Uk KIM, Daejeon (KR)

(73) Assignee: KOREA AEROSPACE RESEARCH INSTITUTE, Daejeon (KR)

(21) Appl. No.: 14/892,642

(22) PCT Filed: Dec. 10, 2014
(86) PCT No.: PCT/KR2014/012130

§ 371 Date: Nov. 20, 2015

(30) Foreign Application Priority Data
Dec. 8, 2014 (KR) 10-2014-0174682

(51) Int. Cl. B64C 3/26; H02S 20/00; H02S 30/00; B64C 3/18

(52) U.S. Cl. CPC B64C 3/26; B64C 3/185; B64C 3/187; H02S 20/00; H02S 30/00; B64D 2211/00

(57) ABSTRACT

Disclosed is a solar panel device provided on an aircraft wing, which can realize solar panels that are capable of converting sunlight into energy without being damaged due to bending load or movement of a wing, an aircraft wing having such a solar panel device, and an aircraft having such an aircraft wing.

### TECHNICAL FIELD

The present invention relates to a solar panel device provided on an aircraft wing, an aircraft wing having the solar panel device, and an aircraft, and more particularly to a solar panel device provided on an aircraft wing, which can realize solar panels that are capable of converting sunlight into energy without being damaged due to bending load or movement of a wing, an aircraft wing having such a solar panel device, and an aircraft having such an aircraft wing.

### BACKGROUND ART

Recently, in the field of aviation, technology for converting sunlight into electric energy as propulsion energy for flight has been developed.

In order to convert sunlight into electric energy, a solar panel device is needed. Preferably, the solar panel device is mounted on a wing, which is the most suitable place to get sunlight.

However, since solar panels are typically made of highly brittle material, such as wafers, glass, or the like, they may be easily broken even by a small bending force.

Therefore, it is very hard to apply the solar panel to an aircraft because the wing of the aircraft is subjected to bending load and the like by aerodynamic force or gravity during flight, and the bending load is also exerted on the solar panel mounted on the wing.

A wing having a flexible solar panel structure is disclosed in Korean Patent Registration No. 10-1275883.

However, such a conventional wing equipped with a solar panel structure has a problem in that the solar panel structure has curved portions, which create a large difference in height between the surface of the wing and the surface of the solar panels, thereby increasing aerodynamic resistance.

### DISCLOSURE

### Technical Problem

The present invention has been devised to solve the above problems, and it is an object of the present invention to provide a solar panel device provided on an aircraft wing, which can realize solar panels capable of converting sunlight into energy without being damaged due to bending load or movement of a wing, an aircraft wing having such a solar panel device, and an aircraft having such an aircraft wing.

Technical problems to be solved by the present disclosure are not restricted to the above-mentioned description, and any other technical problems not mentioned so far will be clearly appreciated from the following description by those skilled in the art.

### Technical Solution

In accordance with an aspect of the present invention, the above and other objects can be accomplished by the provision of a solar panel device provided on an aircraft wing, including a plurality of solar panels arranged spaced apart from each other in a column direction, which is perpendicular to a longitudinal direction of the wing, in order to form solar modules, the solar modules being arranged spaced apart from each other in a row direction in order to form a solar structure, and a connecting film for connecting the solar panels.

The solar panel device may further include reinforcement plates provided on bottom surfaces of the solar panels.

The solar panel device may further include a base film, to which the solar structure is secured.

The connecting film may include a base portion having a plurality of cavities for securing the solar panels therein and a plurality of column regions defined between the solar modules, and a plurality of securing portions provided around the cavities in order to secure the solar panels in the cavities, each of the securing portions including a vertical portion extending vertically from an edge of each of the cavities and fixed to a lateral surface of each of the solar panels, and a horizontal portion extending inward from the vertical portion and fixed to a top surface or a bottom surface of each of the solar panels.

In accordance with another aspect of the present invention, there is provided an aircraft wing including the above-described solar panel device.

The aircraft wing may further include a frame including a plurality of ribs extending in the column direction and arranged spaced apart from each other in the row direction and a plurality of spars extending in the row direction to connect the ribs, and a skin including a lower skin for covering a bottom of the frame and an upper skin for covering a top of the frame, and the solar panel device may act as the upper skin.

The base portion may be located at a middle portion between the top surface and the bottom surface of each of the solar panels, the vertical portion may extend upward and downward from the edge of each of the cavities, the horizontal portion may be provided in pairs that are bent inward from a top and a bottom of the vertical portion and are fixed to the top and bottom surfaces of each of the solar panels, and the solar panel device may be mounted on the frame such that some of the column regions, which are located corresponding to the ribs, are secured to the ribs.

The frame may further include a plurality of supporting bars extending in the column direction and cross-connected with the spars so as to support the solar panel device with the ribs, and the solar panel device may be mounted such that the column regions are secured to the ribs and the supporting bars.

Alternatively, the aircraft wing may further include a frame including a plurality of ribs extending in the column direction and arranged spaced apart from each other in the row direction and a plurality of spars extending in the row direction to connect the ribs, and a skin including a lower skin for covering a bottom of the frame and an upper skin for covering a top of the frame, and the solar panel device may be mounted on a top surface of the upper skin.

A bottom surface of the base portion may be positioned below or in the same plane as a bottom surface of the solar structure, the vertical portion may extend upward from the edge of each of the cavities, the horizontal portion may extend inward from a top of the vertical portion and may be fixed to the top surface of each of the solar panels, and the solar panel device may be mounted on the top surface of the upper skin such that some of the column regions are securely seated on positions corresponding to the ribs.

The frame may further include a plurality of supporting bars extending in the column direction and cross-connected with the spars so as to support the solar panel device with the ribs, and the solar panel device may be mounted on the top surface of the upper skin such that the column regions are securely seated on the positions corresponding to the ribs and the supporting bars.

The solar panel device may further include a base film, to which the solar structure and the base portion are secured, and the base film may be fixed to the upper skin such that adhesion regions, which correspond to the column regions, are located at positions corresponding to the ribs and the supporting bars.

Alternatively, the aircraft wing may further include a frame including a plurality of ribs extending in the column direction and arranged spaced apart from each other in the row direction and a plurality of spars extending in the row direction to connect the ribs, and a skin including a lower skin for covering a bottom of the frame and an upper skin for covering a top of the frame, and the solar panel device may be mounted on a bottom surface of the upper skin.

A top surface of the base portion may be positioned above or in the same plane as a top surface of the solar structure, the vertical portion may extend downward from the edge of each of the cavities, the horizontal portion may extend inward from a bottom of the vertical portion and may be fixed to the bottom surface of each of the solar panels, and the solar panel device may be mounted such that a top surface of the column regions is fixed to the bottom surface of the upper skin and some of the column regions, which are located corresponding to the ribs, are secured to the ribs.

The frame may further include a plurality of supporting bars extending in the column direction and cross-connected with the spars so as to support the solar panel device with the ribs, and the solar panel device may be mounted such that the column regions are secured to the ribs and the supporting bars.

Each of the ribs may include a rib plate extending in the column direction and having an airfoil shape and upper and lower flanges extending in the row direction from a top and a bottom of the rib plate, the rib plate may have a plurality of coupling holes formed in a longitudinal direction thereof, and each of the spars may be fitted through any one of the coupling holes.

Diameters of the coupling holes may be gradually decreased from a leading edge to a trailing edge in the longitudinal direction of the rib plate.

The supporting bars may be disposed between the spars, and each of the spars may have coupling slots arranged in a longitudinal direction thereof, in which the supporting bars are fitted.

The aircraft wing may further include reinforcement plates provided on the bottom surfaces of the solar panels.

In accordance with a further aspect of the present invention, there is provided an aircraft including the above-described aircraft wing.

### Advantageous Effects

The present invention has the effect of allowing solar panels to be mounted on an aircraft wing without being damaged due to bending load or movement of the wing.

Effects of the present invention are not restricted to the above-mentioned description, and any other effects not mentioned so far will be clearly appreciated from the following description by those skilled in the art.

### DESCRIPTION OF DRAWINGS

FIG. 1 is a plan view illustrating a solar panel device according to an embodiment of the present invention;

FIG. 2 is an operational state view illustrating a solar panel device provided on an aircraft wing according to an embodiment of the present invention;

FIG. 3 is a perspective view illustrating an aircraft wing to which the solar panel device according to an embodiment of the present invention is mounted;

FIG. 4 is a conceptual view illustrating the state in which the solar panel device according to an embodiment of the present invention is mounted to an aircraft wing;

FIG. 5 is a conceptual view illustrating the state in which the solar panel device according to an embodiment of the present invention is mounted to an aircraft wing;

FIG. 6 is a conceptual view illustrating the state in which the solar panel device according to an embodiment of the present invention is mounted to an aircraft wing; and

FIG. 7 is a conceptual view illustrating the state in which the solar panel device according to an embodiment of the present invention is mounted to an aircraft wing.

### BEST MODE

Now, preferred embodiments of the present invention will be described in detail with reference to the attached drawings.

Referring to FIGS. 1 through 7, a solar panel device 1 (hereinafter, referred to as a “panel device”) provided on an aircraft wing according to the present invention is a panel device that is configured to be mounted to a wing 100 of an aircraft 200. The panel device 1 includes a plurality of solar panels 10, which are arranged spaced apart from each other in a column direction, which is perpendicular to the longitudinal direction of the wing 100, in order to form solar modules A, the solar modules A being arranged spaced apart from each other in a row direction in order to form a solar structure B, and further includes a connecting film 20 for connecting the solar panels 10.

Herein, the row direction in which the solar panels 10 are arranged may be defined as the longitudinal direction of the wing 100, and the column direction may be defined as the forward-backward direction, which is perpendicular to the longitudinal direction of the wing 100. Therefore, it is preferable to regard the row direction and the column direction, which will be described below, as the longitudinal direction of the wing 100 and the direction perpendicular to the longitudinal direction of the wing 100, respectively.

The solar module A should be understood to refer to the state in which a plurality of solar panels 10 is arranged in the column direction, and the solar structure B should be understood to refer to the state in which a plurality of solar modules A is arranged in the row direction.

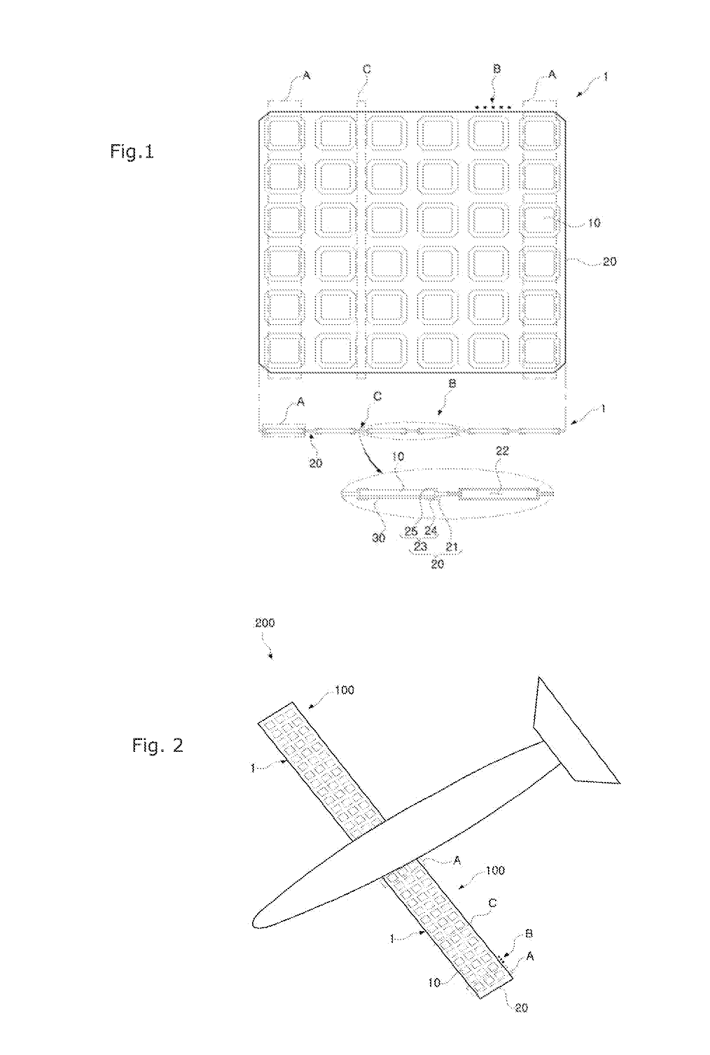

The aircraft 200, as shown in FIG. 2, may be a passenger airplane, an unmanned reconnaissance aircraft, a wire-controlled or radio-controlled aircraft, or the like.

The solar panels 10 are provided on the wing 100 in order to convert solar energy into the electric energy required by the aircraft 200.

The respective solar panels 10 have a quadrangular shape, and are spaced apart from the adjacent solar panels 10 by a regular distance in the row and column directions, thereby forming the solar structure B.

The panel device 1, whose solar structure B is mounted on the wing 100, may serve to generate aerodynamic force.

The connecting film 20 is embodied as a thin polymer plastic film, and serves to allow the solar panels 10, which form the solar structure B, to be connected while being spaced apart from each other.

Further, the connecting film 20 serves to allow the solar structure B to be mounted to the wing 100 with a gap therebetween, without being adhered to the wing 100.

This serves to prevent the region between the solar panels 10 from being bent and damaged due to bending load transmitted from the wing 100, and to prevent the bending load from the wing 100 from being transmitted to the solar panels 10.

The panel device 1, as shown in FIG. 1, may further include reinforcement plates 30, which are provided on the bottom surfaces of the solar panels 10.

The reinforcement plates 30 may be made of a metal material, a composite material or the like, and may serve to prevent damage to the solar panels 10 attributable to movement of the wing 100.

The wing 100 includes a frame 110, which extends in the row direction and has one end connected with the body of the aircraft 200, and a skin 120, which covers the frame 110.

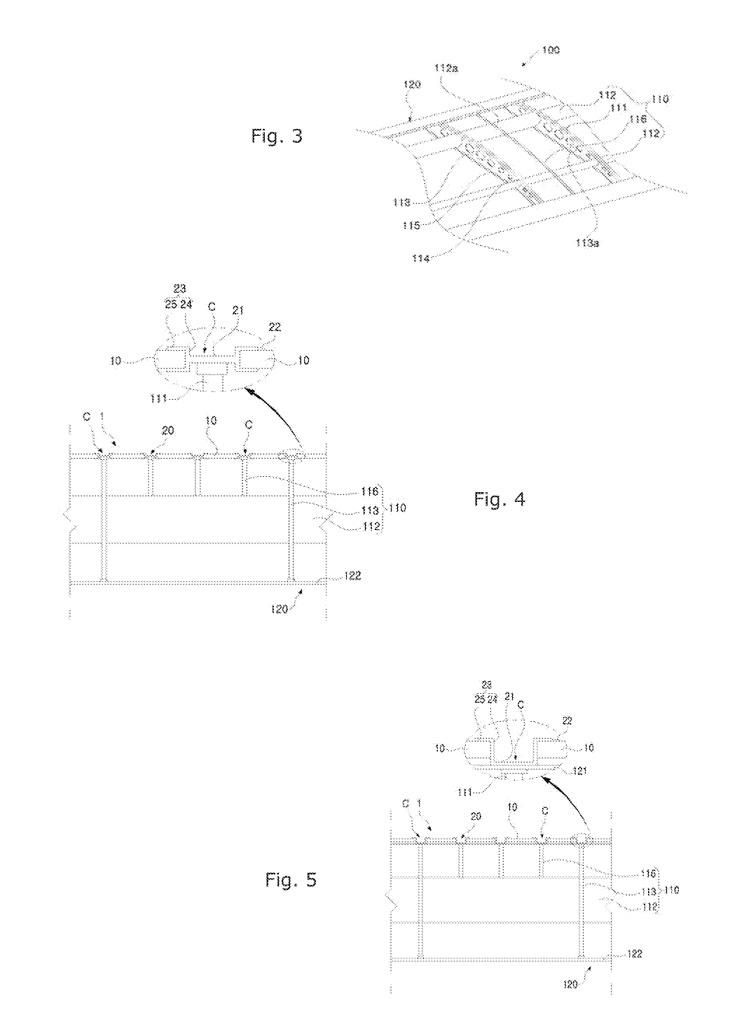

The frame 110, as shown in FIG. 3, includes a plurality of ribs 111, which extend in the column direction and are arranged spaced apart from each other in the row direction, and a plurality of spars 112, which extend in the row direction and connect the ribs 111.

Each of the ribs 111 includes a rib plate 113, which extends in the column direction and has an airfoil shape with a curved top and bottom, and upper and lower flanges 114 and 115, which extend in the row direction from the top and bottom of the rib plate 113.

The ribs 111 have an I-shaped longitudinal section due to the connection between the rib plate 113 and the upper and lower flanges 114 and 115, and the skin 120 covers the frame 110 while contacting the upper and lower flanges 114 and 115.

The rib plate 113 has a plurality of coupling holes 113a formed in the longitudinal direction thereof.

The coupling holes 113a serve to reduce the weight of the rib plate 113, thereby ultimately reducing the weight of the whole wing 100, and also serve to ensure stable engagement of the spars 112. Each of the spars 112 is coupled to the ribs 111 by passing through any one of the coupling holes 113a respectively formed in the ribs 111.

Preferably, the spars 112 are provided in pairs. It is also preferable that one of the pair of spars 112, which is positioned near the leading edge of the rib, has a diameter larger than that of the other spar, which is positioned near the trailing edge of the rib.

Moreover, preferably, the diameters of the coupling holes 113a are gradually decreased from the leading edge to the trailing edge in the longitudinal direction of the rib plate 113.

The skin 120 includes an upper skin 121 for covering the top of the frame 110 and a lower skin 122 for covering the bottom of the frame 110.

The frame 110 may further include a plurality of supporting bars 116, which extend in the column direction to be connected with the spars 112 and have a top surface positioned in the same plane as the top surface of the ribs 111, thereby supporting the upper skin 121.

Each of the supporting bars 116 is disposed between the ribs 111, and each of the spars 112 has a plurality of coupling slots 112a, which are arranged in the longitudinal direction thereof and in which the supporting bars 116 are fitted.

The connecting film 20 is configured as a pair of upper and lower films, which are adhered to each other and have a plurality of cavities 22 in which the solar panels 10 are received, thereby connecting the solar panels 10.

In detail, the connecting film 20 may include a base portion 21, which has a plurality of cavities 22 for securing the solar panels 10 therein and column regions C defined between the solar modules A, and a plurality of securing portions 23 provided around the cavities 22 in order to secure the solar panels 10 in the cavities 22.

Each of the securing portions 23, as shown in FIG. 1, includes a vertical portion 24, which extends vertically from the edge of each of the cavities 22, and a horizontal portion 25, which extends inward from the vertical portion 24.

The panel device 1, as shown in FIG. 4, may act as the upper skin 121.

As an example, as shown in FIG. 4, the vertical portion 24 extends upward and downward from the edge of each of the cavities 22, and the horizontal portion 25 is provided in pairs that are bent inward from the top and bottom of the vertical portion 24.

That is, the vertical portion 24 and the pair of horizontal portions 25 are integrally connected, and thus the securing portion 23 has a substantially 90° rotated U-shaped longitudinal section that opens inward.

When the panel device 1 is mounted on the frame 110, the column regions C are seated on the ribs 111 and the supporting bars 116, and are fixed to them using adhesive or the like.

The solar structure B is separated from the frame 110 without being adhered to the same.

Accordingly, the panel device 1 can generate aerodynamic force using the solar structure B. Further, since the solar structure B is separated from the frame 110, it can prevent damage to the solar panels 10 attributable to bending load or the like transmitted from the wing 100.

The panel device 1, as shown in FIG. 5, may be mounted on the upper skin 121.

As an example, as shown in FIG. 5, the vertical portion 24 extends upward from the edge of each of the cavities 22, and the horizontal portion 25 is bent inward from the top of the vertical portion 24.

That is, the vertical portion 24 and the horizontal portion 25 are integrally connected, and thus the securing portion 23 has a substantially reversed L-shaped longitudinal section that opens inward and downward.

The bottom surface of the base portion 21 is positioned below or in the same plane as the bottom surface of the solar structure B.

When the panel device 1 is mounted on the top surface of the upper skin 121, the column regions C are located at the positions corresponding to the ribs 111 and the supporting bars 116, and are fixed using adhesive or the like.

The solar structure B is separated from the upper skin 121 without being adhered to the same.

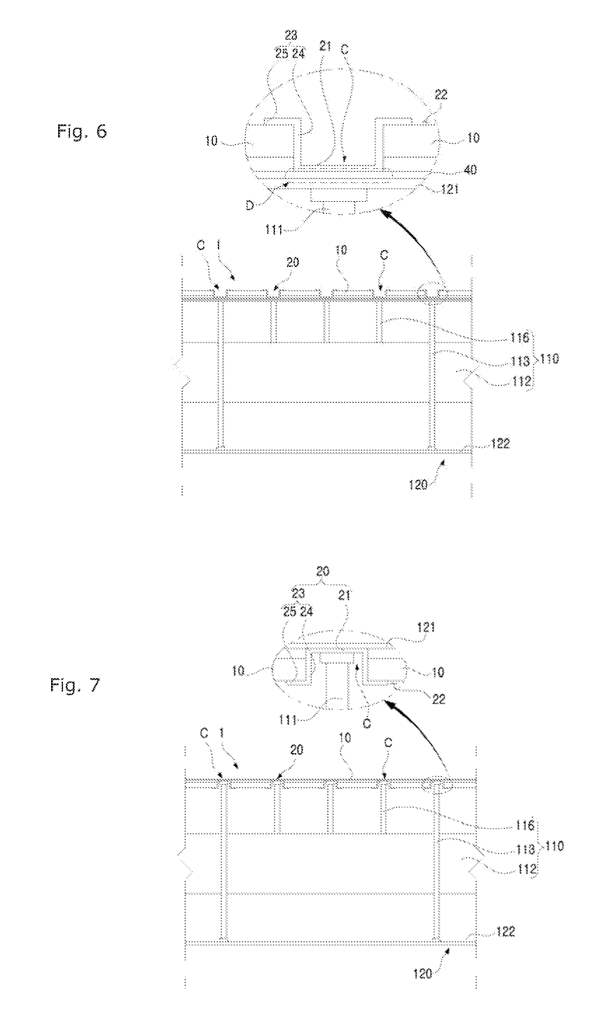

The panel device 1, as shown in FIG. 6, may further include a base film 40, to which the solar structure B and the base portion 21 are secured.

The base film 40 functions to modularize the solar structure B. When the panel device 1 is mounted on the upper skin 121, adhesion regions D, which correspond to the column regions C, are located at the positions corresponding to the ribs 111 and the supporting bars 116, and are fixed using adhesive or the like.

The region of the bottom surface of the base film 40, which corresponds to the solar structure B, is separated from the upper skin 121 without being adhered to the same.

Accordingly, the solar structure B of the panel device 1 is separated from the upper skin 121, thereby preventing damage to the solar panels 10 attributable to bending load or the like transmitted from the wing 100.

The panel device 1, as shown in FIG. 7, may be mounted on the bottom surface of the upper skin 121.

As an example, as shown in FIG. 7, the vertical portion 24 extends downward from the edge of each of the cavities 22, and the horizontal portion 25 is bent inward from the bottom of the vertical portion 24.

That is, the vertical portion 24 and the horizontal portion 25 are integrally connected, and thus the securing portion 23 has a substantially L-shaped longitudinal section that opens inward and upward.

The top surface of the base portion 21 is positioned above or in the same plane as the top surface of the solar structure B.

When the panel device 1 is mounted on the bottom surface of the upper skin 121, the column regions C are fixed to the ribs 111 and the supporting bars 116 using adhesive or the like, and are also fixed to the bottom surface of the upper skin 121.

The solar structure B is separated from the upper skin 121 without being adhered to the same, and thus is prevented from being damaged due to bending load or the like transmitted to the solar panels 10.

Accordingly, the panel device 1 can realize the solar panels 10 that are capable of converting sunlight into energy without being damaged due to bending load or movement of the wing 100.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A solar panel device provided on an aircraft wing, comprising:
a plurality of solar panels arranged spaced apart from each other in a column direction, which is perpendicular to a longitudinal direction of the wing, in order to form solar modules, the solar modules being arranged spaced apart from each other in a row direction in order to form a solar structure; and
a connecting film for connecting the solar panels.

2. The solar panel device according to claim 1, further comprising:
reinforcement plates provided on bottom surfaces of the solar panels.

3. The solar panel device according to claim 1, further comprising:
a base film, to which the solar structure is secured.

4. The solar panel device according to claim 1, wherein the connecting film includes:
a base portion having a plurality of cavities for securing the solar panels therein and a plurality of column regions defined between the solar modules; and
a plurality of securing portions provided around the cavities in order to secure the solar panels in the cavities,
and wherein each of the securing portions includes:
a vertical portion extending vertically from an edge of each of the cavities and fixed to a lateral surface of each of the solar panels; and
a horizontal portion extending inward from the vertical portion and fixed to a top surface or a bottom surface of each of the solar panels.

5. An aircraft wing, comprising the solar panel device according to claim 4.

6. The aircraft wing according to claim 5, further comprising:
a frame including a plurality of ribs extending in the column direction and arranged spaced apart from each other in the row direction, and a plurality of spars extending in the row direction to connect the ribs; and
a skin including a lower skin for covering a bottom of the frame and an upper skin for covering a top of the frame,
wherein the solar panel device acts as the upper skin.

7. The aircraft wing according to claim 6, wherein the base portion is located at a middle portion between the top surface and the bottom surface of each of the solar panels,
the vertical portion extends upward and downward from the edge of each of the cavities,
the horizontal portion is provided in pairs that are bent inward from a top and a bottom of the vertical portion and are fixed to the top and bottom surfaces of each of the solar panels, and
the solar panel device is mounted on the frame such that some of the column regions, which are located corresponding to the ribs, are secured to the ribs.

8. The aircraft wing according to claim 7, wherein the frame further includes a plurality of supporting bars extending in the column direction and cross-connected with the spars so as to support the solar panel device with the ribs, and
the solar panel device is mounted such that the column regions are secured to the ribs and the supporting bars.

9. The aircraft wing according to claim 5, further comprising:
a frame including a plurality of ribs extending in the column direction and arranged spaced apart from each other in the row direction, and a plurality of spars extending in the row direction to connect the ribs; and
a skin including a lower skin for covering a bottom of the frame and an upper skin for covering a top of the frame,
wherein the solar panel device is mounted on a top surface of the upper skin.

10. The aircraft wing according to claim 9, wherein a bottom surface of the base portion is positioned below or in the same plane as a bottom surface of the solar structure,
the vertical portion extends upward from the edge of each of the cavities,
the horizontal portion extends inward from a top of the vertical portion and is fixed to the top surface of each of the solar panels, and
the solar panel device is mounted on the top surface of the upper skin such that some of the column regions are securely seated on positions corresponding to the ribs.

11. The aircraft wing according to claim 10, wherein the frame further includes a plurality of supporting bars extending in the column direction and cross-connected with the spars so as to support the solar panel device with the ribs, and
the solar panel device is mounted on the top surface of the upper skin such that the column regions are securely seated on positions corresponding to the ribs and the supporting bars.

12. The aircraft wing according to claim 11, wherein the solar panel device further includes a base film, to which the solar structure and the base portion are secured, and
the base film is fixed to the upper skin such that adhesion regions, which correspond to the column regions, are located at positions corresponding to the ribs and the supporting bars.

13. The aircraft wing according to claim 5, further comprising:
a frame including a plurality of ribs extending in the column direction and arranged spaced apart from each other in the row direction, and a plurality of spars extending in the row direction to connect the ribs; and
a skin including a lower skin for covering a bottom of the frame and an upper skin for covering a top of the frame,
wherein the solar panel device is mounted on a bottom surface of the upper skin.

14. The aircraft wing according to claim 13, wherein a top surface of the base portion is positioned above or in the same plane as a top surface of the solar structure,
the vertical portion extends downward from the edge of each of the cavities,
the horizontal portion extends inward from a bottom of the vertical portion and is fixed to the bottom surface of each of the solar panels, and
the solar panel device is mounted such that a top surface of the column regions is fixed to the bottom surface of the upper skin and some of the column regions, which are located corresponding to the ribs, are secured to the ribs.

15. The aircraft wing according to claim 14, wherein the frame further includes a plurality of supporting bars extending in the column direction and cross-connected with the spars so as to support the solar panel device with the ribs, and
the solar panel device is mounted such that the column regions are secured to the ribs and the supporting bars.

16. The aircraft wing according to claim 6, wherein each of the ribs includes:
a rib plate extending in the column direction and having an airfoil shape; and
upper and lower flanges extending in the row direction from a top and a bottom of the rib plate,
and wherein the rib plate has a plurality of coupling holes formed in a longitudinal direction thereof, and each of the spars is fitted through any one of the coupling holes.

17. The aircraft wing according to claim 16, wherein diameters of the coupling holes are gradually decreased from a leading edge to a trailing edge in the longitudinal direction of the rib plate.

18. The aircraft wing according to claim 8, wherein the supporting bars are disposed between the spars, and
each of the spars has coupling slots arranged in a longitudinal direction thereof, in which the supporting bars are fitted.

19. The aircraft wing according to claim 4, further comprising:
reinforcement plates provided on the bottom surfaces of the solar panels.

20. An aircraft, comprising the aircraft wing according to claim 5.

21. The aircraft wing according to claim 9, wherein each of the ribs includes:
a rib plate extending in the column direction and having an airfoil shape; and
upper and lower flanges extending in the row direction from a top and a bottom of the rib plate,
and wherein the rib plate has a plurality of coupling holes formed in a longitudinal direction thereof, and each of the spars is fitted through any one of the coupling holes.

22. The aircraft wing according to claim 13, wherein each of the ribs includes:
a rib plate extending in the column direction and having an airfoil shape; and
upper and lower flanges extending in the row direction from a top and a bottom of the rib plate,
and wherein the rib plate has a plurality of coupling holes formed in a longitudinal direction thereof, and each of the spars is fitted through any one of the coupling holes.

23. The aircraft wing according to claim 11, wherein the supporting bars are disposed between the spars, and
each of the spars has coupling slots arranged in a longitudinal direction thereof, in which the supporting bars are fitted.

24. The aircraft wing according to claim 15, wherein the supporting bars are disposed between the spars, and
each of the spars has coupling slots arranged in a longitudinal direction thereof, in which the supporting bars are fitted.
